(19) United States
(12) Patent Application Publication
(10) Pub. No.: US 2006/0100965 A1
(43) Pub. Date: May 11, 2006

(54) Digital content after-market broker system, method, apparatus and computer program

(75) Inventor: Kim Simelius, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/985,141

(22) Filed: Nov. 10, 2004

(51) Int. Cl. G06F 17/60

(52) U.S. Cl. 705/59

(57) ABSTRACT

In one aspect thereof this invention provides a system and a method to operate a network node to facilitate conveying rights to digital content. The method includes forming a record in a collection of records of an occurrence of an acquisition of rights to a certain digital content by a first party and, in response to a receipt of a request through the network from a second party to obtain rights to the certain digital content, to examine the records and, if the record is found, to contact the first party through the network to solicit the first party to relinquish at least some remaining rights to the digital content, if any, held by the first party.

### TECHNICAL FIELD

The presently preferred embodiments of this invention relate generally to digital content distribution and, more specifically, relate to techniques for fulfilling requests to purchase digital content and attendant digital rights management (DRM) implications.

### BACKGROUND

The current development towards truly mobile computing and networking has resulted in the development of various access technologies, which also provide users with access to the Internet when they are outside their own home network. The first public communication network that provides a truly ubiquitous World Wide Web (WWW) access is the GSM-based mobile telephone network.

The use of the Internet thus far has been dominated by person-to-machine communications, i.e., information services. The evolution towards so-called third generation (3G) wireless networks involves as well the introduction of mobile multimedia communications, which change the manner in which IP-based services are utilized in public mobile networks.

Multimedia capable mobile terminals (multimedia phones) provide an open development platform for application developers, allowing independent application developers to design new services and applications for the multimedia environment. Users may, in turn, download new content, such as music or software, to their mobile terminals. Therefore, a mechanism is also required in the network for protecting the rights of the content owners and for preventing illegal use of the content.

Digital Rights Management (DRM) is a technology developed for securing, selling, and distributing digital content in a mobile environment. As originally specified the Open Mobile Alliance (OMA) DRM specification includes three levels of functionality, which are termed forward lock, combined delivery, and separate delivery. In forward lock, a hard-coded feature in the terminal prevents the user from copying or forwarding the content downloaded in the terminal. Typical present-day downloadable content, such as ringing tones or logos, is protected by the forward lock mechanism. In combined delivery, a rights definition, termed a rights object (RO), is added to the DRM message delivered to a terminal. The DRM message thus includes two elements: the content and the rights object. The rights object defines permissions and constraints for the usage of the content, such as the number of days or the number of times the content may be used. The combined delivery also utilizes forward lock: neither the content nor the rights object can be forwarded after they have been downloaded to a terminal. In the separate delivery mode, which is intended to protect higher value content, the content and the rights object maybe delivered separately. The content is encrypted into a so-called DRM Content Format (DCF) and the rights object contains a key (CEK, Content Encryption Key) for decrypting the content in the receiving terminal. The content may thus be delivered through an insecure channel, while a more secure channel is used to deliver the rights object. Typically, a Wireless Application Protocol (WAP) push is used to deliver the rights object via a Short Message Service (SMS) message.

The separate delivery mode of operation enables so-called super-distribution, which allows the content, but not the rights object, to be forwarded to another terminal. When the content is to be forwarded, metadata including location information of the application server of the issuer of the rights is inserted in the DCF object to be forwarded. The terminal receiving the DCF object, i.e. the content, contacts the application server by opening a browsing session, which allows the user to choose the desired type of rights. The rights object having the key required for decrypting the content is then delivered through a secure channel to the terminal.

The purchasing of digital content, such as multi-media digital content, is expected to shift to networks from physical stores. As such, and assuming that the DRM issues are resolvable, one may expect that a second-hand market for digital content will come into existence, just as there has long been a second hand market for more conventional content such as books and audio and video recordings.

However, re-selling digital content is more difficult than re-selling physical content, such as books or phonograph records, due at least to the presence of the DRM mechanism.

### SUMMARY OF THE PREFERRED EMBODIMENTS

The foregoing and other problems are mitigated, and other advantages are realized, in accordance with the presently preferred embodiments of this invention.

In certain aspects thereof this invention provides a system and a method to operate a network node to facilitate conveying rights to digital content. The method includes forming a record in a collection of records of an occurrence of an acquisition of rights to a certain digital content by a first party and, in response to a receipt of a request through the network from a second party to obtain rights to the certain digital content, to examine the records and, if the record is found, to contact the first party through the network to solicit the first party to relinquish at least some remaining rights to the digital content, if any, held by the first party.

In another aspect thereof this invention provides a network node having a controller coupled to a memory and to a network interface. The controller operates in accordance with a stored program to facilitate conveying rights to digital content by forming a record in a collection of records stored in the memory of an occurrence of an acquisition of rights to a certain digital content by a first party, and in response to a receipt of a request through the network interface from a second party to obtain rights to the certain digital content, to examine the collection of records and, if the record is found, to contact the first party through the network interface to solicit the first party to relinquish at least some remaining rights to the digital content, if any, held by the first party.

In a still further aspect thereof this invention provides a method to operate a terminal of a communication system, and a terminal that operates in accordance with the method. The method includes, in response to a user indicating a desire to acquire consumption rights to a certain digital content, browsing an on-line catalog maintained by an After-Market Digital Content Broker server and, in response to locating available consumption rights to the certain digital content in the on-line catalog, contacting the After-Market Digital Content Broker server to make an acquisition request for at least some of the consumption rights to the certain digital content.

In another further aspect thereof this invention provides a further method to operate a terminal of a communication system, and a terminal that operates in accordance with the further method. In this further method, and in association with a user acquiring consumption rights to a certain digital content, the method receives a request for permission to register, in a database of the After-Market Digital Content Broker server, that the consumption rights have been acquired; responds one of affirmatively or negatively to the request and, if responding affirmatively, subsequently receives a solicitation from the After-Market Digital Content Broker server to relinquish at least some remaining consumption rights, if any.

Still further in accordance with the embodiments of this invention there are provided methods, apparatus, digital storage medium embodying computer program product, and methods to conduct business through a communications network. For example, there is provided a method to operate a network node to facilitate conveying consumption rights to digital content, where the method includes contacting at least one source of consumption rights to a certain digital content; obtaining, from the at least one source, consumption rights to multiple instances of the certain digital content; and in response to a receipt of requests through the network to obtain consumption rights to the certain digital content, transferring obtained consumption rights to at least one instance of the certain digital content to a first requestor and transferring obtained consumption rights to at least one other instance of the certain digital content to a second requestor. In this non-limiting embodiment the source may comprise a wholesaler of the consumption rights. In this non-limiting embodiment the obtaining step can comprise purchasing an ability to obtain consumption rights for a certain price in the future. In this non-limiting embodiment the obtaining step can comprise obtaining consumption rights through an auction process.

In accordance with still further embodiments of this invention there is provided a method to conduct business through a communications network that comprises locating through the network at least one seller of consumption rights to a digital content; obtaining from the at least one seller an option to purchase consumption rights to the digital content for a certain price in the future and, in response to a request to purchase consumption rights to the digital content, at least one of exercising the option and re-selling purchased consumption rights to the requester, or selling the requestor all or part of the option.

### BRIEF DESCRIPTION OF THE DRAWINGS

The foregoing and other aspects of the presently preferred embodiments of this invention are made more evident in the following Detailed Description of the Preferred Embodiments, when read in conjunction with the attached Drawing Figures, wherein:

FIG. 1 illustrates an example of a communication environment in which the principles of the embodiments of this invention may be beneficially implemented;

FIG. 2 is a block diagram illustrating the basic elements of one embodiment of a mobile terminal according to the invention;

FIG. 3 is a block diagram of an After-Market Digital Content Broker (AMDCB) server, shown in FIG. 1, in accordance with preferred embodiments of this invention;

FIG. 4 illustrates the basic elements of a mobile terminal according to one embodiment of the invention; and

FIG. 5 is a logic flow diagram that is illustrative of a method in accordance with embodiments of this invention.

### DETAILED DESCRIPTION OF THE PREFERRED EMBODIMENTS

The embodiments of this invention grow from a realization by the inventor that a broker function is preferred for accomplishing the redistribution of digital content, i.e., a broker function to facilitate the re-sale of digital content and to thus establish an after-market for digital content. A problem with after-market brokers generally, however, is that there can be many of them, making it difficult for a user to locate the specific content that the user is interested in.

Internet search engines may be used to locate information of interest to a user. A limitation of current Internet search engines is, however, that server-side automated pages cannot be searched, since the content is automatically generated on such pages upon a specific request. Therefore, current search engines are unlikely to locate a significant number of content brokers′ pages, assuming that they operate to automatically generated content in response to user inquiries.

An aspect of this invention is thus a system wherein a user enters a request for digital content. The user may also inform the system of any digital content that the user wishes to sell. The system furthermore preferably maintains records of bought and sold digital content, and when there is an outstanding request this information can be used to locate the digital content. In other words, the system is able to locate a (potential) seller of the digital content since the system has knowledge of who has previously purchased the digital content. The current content owner may be willing to sell the digital content, or to trade the digital content for other digital content, if the digital content has already been consumed by the current content owner, and assuming that there are still DRM rights remaining on the voucher associated with the digital content (e.g., that an expiration date has not yet been reached, and/or that some specified number of uses have not been equaled). The system may then automatically solicit the previous purchaser of the digital content to inquire as to whether the current owner wishes to sell all or at least some remaining rights in the digital content.

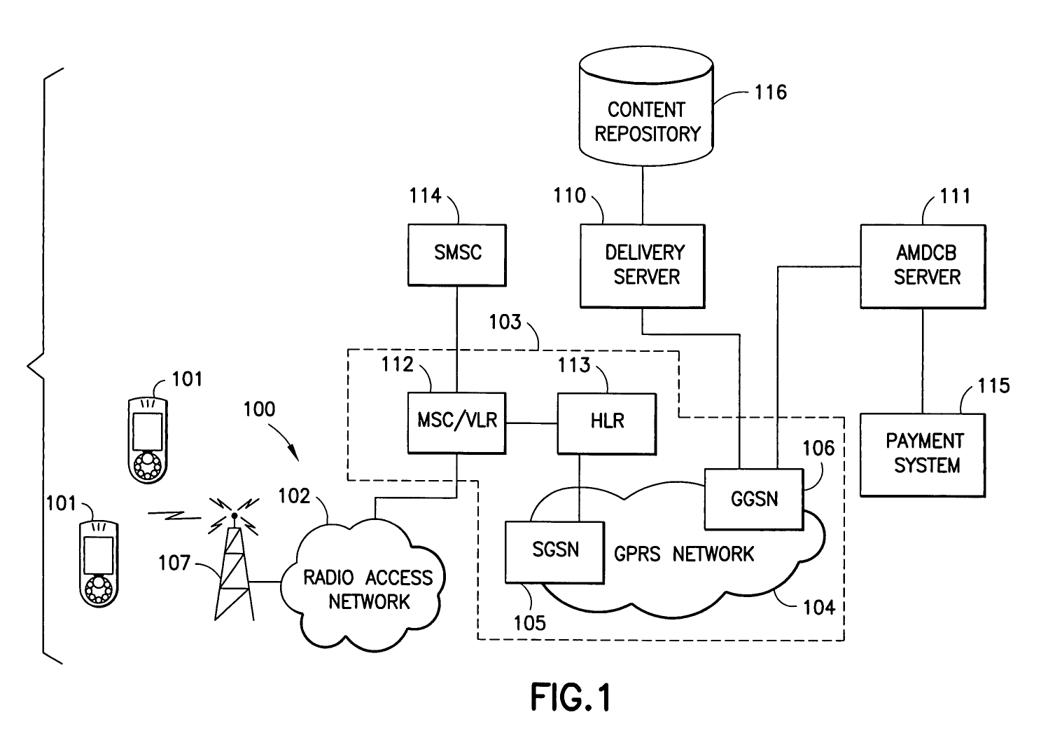

The foregoing and other functionality is encompassed by a network element or network node referred to herein for convenience, and not by way of limitation, as an After-Market Digital Content Broker (AMDCB) function that is embodied in an AMDCB server 111, as shown in FIG. 1.

By way of introduction, FIG. 1 shows a non-limiting example of a general communication environment in which the present invention can be applied. A wireless communications system, such as a cellular system 100, has three interacting domains: user equipment, also referred to as mobile terminals 101, a Radio Access Network (RAN) 102, and a Core Network (CN) 103. The Core Network 103 is divided into circuit-switched and packet-switched domains, the former being responsible for the traditional circuit-switched services and the latter for packet-switched services. The circuit-switched domain is connected via a Mobile services Switching Center (MSC) 112 and the packet-switched domain, which is formed by a General Packet Radio Service (GPRS) network 104, via a Serving GPRS Support Node (SGSN) 105, to the Radio Access Network 102. The MSC 112 comprises a Visitor Location Register (VLR), which is a database holding copies of the service profiles of visiting users and information on the location of the mobile terminals 101. The MSC/VLR is further connected to external circuit-switched networks, such as Public Switched Telephone Networks (PSTNs). Some network elements of the Core Network 103, such as the Home Location Register (HLR) 113, are shared by the packet-switched domain and the circuit-switched domain. The Radio Access Network 102 includes a plurality of base stations 107 with which mobile terminals 101 communicate through a radio interface. The user of a mobile terminal 101 is thus a subscriber in a cellular communication system, such as the GSM or UMTS system.

In this non-limiting example, a delivery server 110 and the After-Market Digital Content Broker server 111 are connected to the GPRS network 104, either directly or through another packet data network, such as the public Internet. Although FIG. 1 so shows, the servers 110 and 111 do not have to be connected to the GPRS network through the same GGSN.

The delivery server 110 stores, or has access to, a content repository 116 which stores media objects that may be downloaded to the mobile terminals. It is further assumed here that the delivery server 110 is the network element responsible for sending the rights objects to the mobile terminals 101 that have downloaded content from the server, i.e. that the delivery server 110 also acts as the issuer of the rights objects, also referred to herein as rights vouchers. As indicated above, the rights objects may be transmitted to the mobile terminals 101 through a Short Message Service Center (SMSC) 114, for example, which is the network element that stores and forwards the short messages sent in the cellular system. The SMSC 114 is connected to the MSC 112 through a signaling network, such as the SS7 network.

The foregoing various blocks and functions, including the terminals 101, may be considered to be network nodes.

For the purposes of this invention, the digital content is assumed to be DRM-protected content, where there is an associated rights voucher that gives the consumption rights for the content. The rights voucher is assumed to be transferable so that the content consumption rights can be re-sold or otherwise transferred to another party. The consumption of digital content is to be broadly construed to include any use of the digital content including, as non-limiting examples, playback of the digital content, display of the digital content and storage of the digital content.

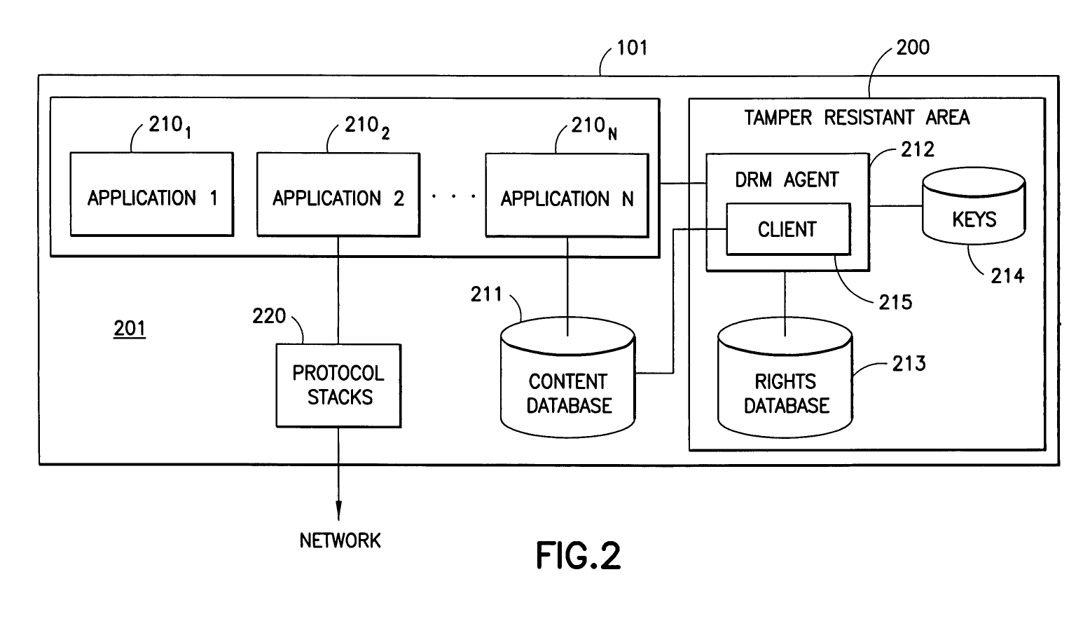

For the purposes of this invention, the terminals 101 are devices having a capability to connect to a distribution network, and capabilities to consume DRM-protected content. The terminals 101 may, however, have a client 215 (shown in FIG. 2) that can be coupled for communication to the AMDCB server 111, also referred to as a broker system, that may monitor offers to sell and buy on the broker system, as well as to publish the status of the consumption rights in the terminal 101 to the broker system so that the broker system can locate those other devices and terminals where there are remaining consumption rights on an item of digital content of interest.

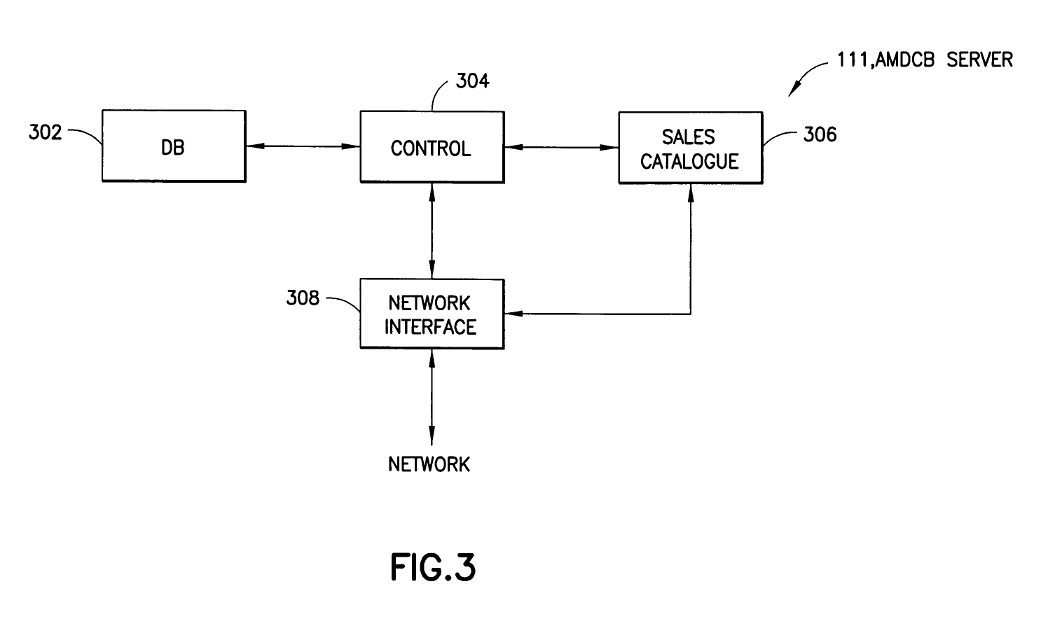

As was noted briefly above, the AMDCB server, or more simply the broker system 111, is a network element that enables a user to locate and obtain digital content, such as media objects, and associated rights objects. As is shown more particularly in FIG. 3, the broker system 111 functions not only as a “normal” broker by tracking offers to sell and to buy, but also maintains information on where consumption rights for specific items of digital content may or do reside. For example, when an item is sold, such as by the delivery server 110 from the content repository 116, the purchaser may be requested to agree to saving a record of the purchase in a database 302 associated with the broker system 111. Note that the broker system, or more specifically the After-Market Digital Content Broker server 111, and the delivery server 110 may be co-located, and their functionality may be combined into one network server. Alternatively, and as is shown in FIG. 1, they may be separate and distinct network elements. In either case, the digital content purchase information is saved in the database 302. Alternatively, or in addition, the users of the system 100 may submit data on remaining consumption rights to the After-Market Digital Content Broker server 111 using the client 215 in the terminal 101, and also indicate their willingness to sell (or barter or exchange) any remaining consumption rights.

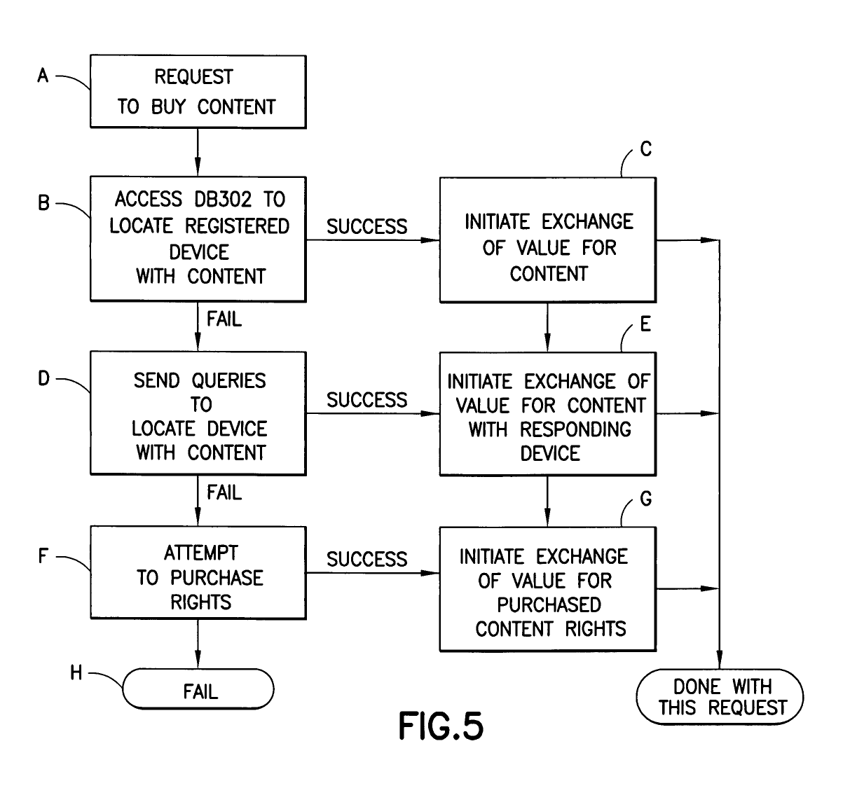

Referring also to FIG. 5, when there is a request to buy an item of digital content (block A), a controller 304 of the broker system, in this case embodied in the After-Market Digital Content Broker server 111, accesses the database 302 and attempts to locate a device or terminal that has previously registered the fact that it has remaining rights that are available for the requested item of digital content (block B). If successful, the After-Market Digital Content Broker server 111 contacts the identified device or terminal and initiates the exchange of monetary value for the remaining rights, possibly using a payment system 115 in FIG. 1, or otherwise arranges the exchange, such as for other rights as a swap or exchange (block C). The payment system 115 may be any system suitable for online electronic commerce payments.

It is noted that prior to the transfer of rights and the payment, the After-Market Digital Content Broker server 111 may query the client 215 for the client's willingness to sell or trade the content at a certain price. The client 215 may then, in response, query the prompt the owner of the terminal 101 with a question. Alternatively, the client 215 may act automatically to one of accept or decline the offer.

It can be noted that once having registered the availability of a rights voucher for some specific digital content, the terminal 101 may be blocked from consuming further content rights as described in commonly assigned Finnish Patent Application 20040553, filed Apr. 19, 2004, entitled “Control of Consumption of Media Objects”, as well as in corresponding U.S. patent application Ser. No. 10/______, filed Jul. 1, 2004. The commonly assigned patent application also provides for accepting sales parameters from a user, where the sales parameters indicate that rights of consumption of a media object are for sale to a certain extent.

If the request at block B is not successful, the After-Market Digital Content Broker server 111 may send queries to one or more other devices or terminals 101, known to have previously purchased the requested item of digital content based on records stored in the database 302, to determine whether there are any consumption rights remaining, and whether the user would wish to sell or otherwise dispose of the remaining consumption rights (block D). If successful, the After-Market Digital Content Broker server 111 contacts a positively responding device or terminal and initiates the exchange of monetary value for the remaining rights, or otherwise arranges the exchange (block E).

If the request at block D is not successful, the After-Market Digital Content Broker server 111 may attempt to purchase the rights from elsewhere, e.g., from the delivery server 110 or another system (block F). If successful, the After-Market Digital Content Broker server 111 initiates the exchange of monetary value for the purchased rights, or otherwise arranges the exchange (block G). If this is not successful, the current procedure may fail (at least temporarily) until the desired digital content with remaining consumption rights becomes available (block H).

When available consumption rights are found to exist (as at blocks C, E and G), the After-Market Digital Content Broker server 111 preferably then clears the transaction by handling the payment from the buyer to the seller, and arranges for the transfer of rights, perhaps through the distribution system (delivery server 110 and content repository 116) where the rights voucher originated.

In the presently preferred embodiments of this invention the After-Market Digital Content Broker server 111 maintains a list of rights that are available, e.g., a sales catalogue 306, and conducts the transactions between the mobile terminals 101. This sales catalog 306 is preferably available on-line, and is preferably searchable by on-line search engines via a network interface 308, thereby enabling users to locate the After-Market Digital Content Broker server 111. That is, the sales catalogue 306 is preferably not a dynamically-generated type of document, but is instead a document that search engines are capable of examining and indexing.

FIG. 2 is a block diagram of the basic elements of one embodiment of a terminal 101. The entities relevant to the embodiments of this invention reside either in a tamper resistant area 200 of the terminal 101 or in an open platform area 201. In this example, the tamper resistant area 200 includes a trusted agent, which acts as a controlling entity controlling the rights related to different media objects (different items of digital content) stored in the terminal 101. In a DRM environment, the trusted agent acts as a DRM agent 112, i.e. as an entity that enforces the rights and controls the consumption of the media objects residing in the terminal 101. The tamper resistant area 200 further includes a rights database 213 holding the rights objects related to the DRM media objects stored in the terminal, including those rights objects (rights vouchers) obtained using the After-Market Digital Content Broker server 111 as explained above in relation to FIGS. 3 and 5.

The open platform area 201 may include a plurality of applications 210₁ to 210_{N} which may also be downloaded from the delivery server 110. The applications may also reside in a content database 211, which holds DRM content downloaded from one or more delivery servers 110. As described above, when the user of the terminal 101 downloads content, the content and the associated rights object are delivered to the terminal 101, either together or separately. The DRM agent 212 stores the content in the content database 211 and the associated rights object in the rights database 213 residing in the tamper resistant area 200 of the terminal 101. The applications 210₁ to 210 _{N} access the RAN 102 and other networks through a protocol stack 220, which may be a (w)TCP/IP stack, for example.

The tamper resistant area 200 may further include a separate key database 214 for the keys needed in the DRM system. The keys include the content encryption keys needed for decrypting the encrypted content, and possibly also other keys or certificates needed in the DRM system. When the user wishes to consume content, the corresponding application 210₁ to 210_{N} contacts the DRM agent 212, which then checks the associated rights object and allows the consumption (i.e. the decryption of the content) if the rights object indicates that the current rights are sufficient for the consumption.

In addition to the above-described normal operation, the DRM agent 212 is assumed to include the functionality for obtaining rights to digital content from the After-Market Digital Content Broker server 111, as well as possibly making unconsumed rights available by advertising their availability with the After-Market Digital Content Broker server 111. It is assumed here that the functionalities required for these purposes are implemented in a separate module of the DRM agent 212, which is herein referred to as the client 215 that was discussed above. The client 215 may also manage and maintain information concerning restrictions imposed on the rights currently owned by the user of the terminal 101.

It should be noted that the operation of the After-Market Digital Content Broker server 111 may correspond to that of existing platforms for trading stocks, commodities and other objects. The After-Market Digital Content Broker server 111 may, for example, maintain an order book for offers and bids, mediate payments between the parties, and log executed transactions. The After-Market Digital Content Broker server 111 may also initiate an auction to locate a seller of a specific content for which a potential buyer exists, or to locate a buyer for content offered for sale by a client.

It should be further appreciated that when demand for a certain digital content exceeds the available supply, an auction process may be triggered whereby a user that offers to pay the most (e.g., money, or to exchange the most other digital content or most valuable other digital content) is granted the desired digital content and associated rights voucher.

It should be noted as well that an oversupply of a certain digital content may initiate a reverse auction process that reduces the price of the content in order to reduce the supply.

When a user of another terminal, here termed terminal B, intends to buy rights for a certain media object, such as the media object terminal A has set for sale, the user may open a trading session with the After-Market Digital Content Broker server 111 and browse the sales catalogue 306 on the After-Market Digital Content Broker server 111 to determine whether the desired rights voucher is available. If the user finds the desired rights voucher and confirms a purchase, the After-Market Digital Content Broker server 111 conducts a sales transaction. This involves deletion of the sell offer from the sales catalogue 306 and the use of the electronic payment system 115 for deducting the agreed sum of money from the account or wallet of the purchasing party and for crediting the account or wallet of the selling party.

Having conducted the sales transaction, the After-Market Digital Content Broker server 111 may initiate the transfer of the rights object to the purchasing party, i.e. to terminal B. The After-Market Digital Content Broker server 111 may generate a new rights object for the terminal 101 purchasing the rights, or it may request the selling terminal 101 to forward the rights object to the purchasing terminal. The transfer of the rights object may take place either directly from the selling terminal to the purchasing terminal, or through the After-Market Digital Content Broker server 111. The DRM agent 212 of the selling party may modify the rights object prior to its transfer to make the rights object consistent with the rights sold, or the modification may be made in the After-Market Digital Content Broker server 111, if the rights object is transferred through it. In another embodiment, the After-Market Digital Content Broker server 111 may request the delivery server 110 to deliver a new rights object to the purchasing terminal 101.

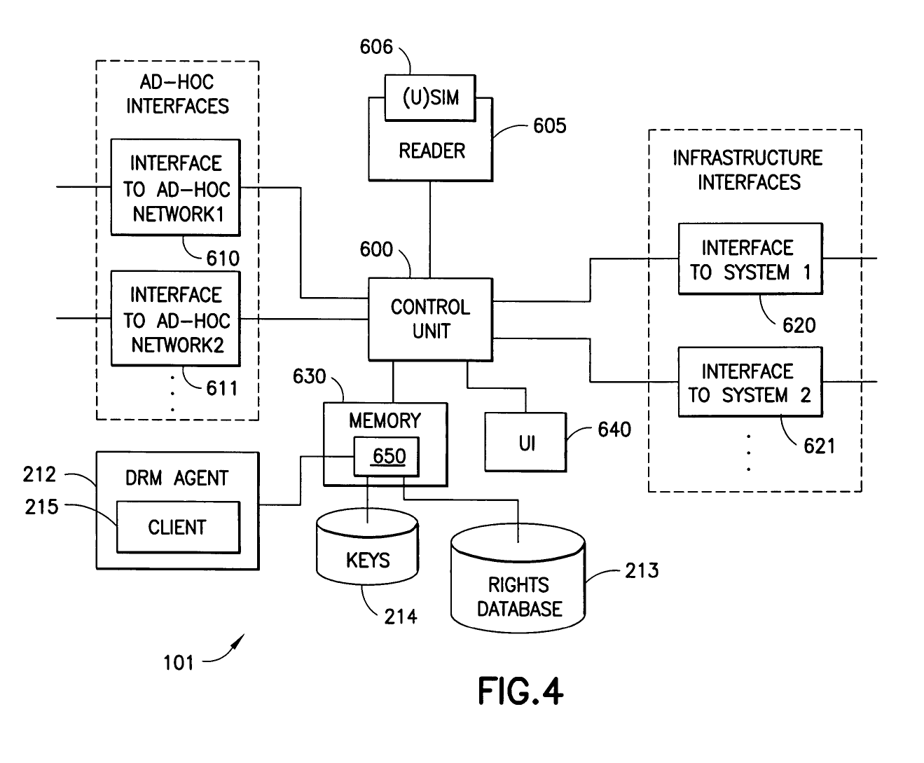

FIG. 4 is a block diagram of a further embodiment of the mobile terminal 101. The core of the terminal is a control unit 600, which is connected to various interfaces of the terminal 101 and to a memory unit 630. The mobile terminal 101 may be an ad-hoc terminal, for example, in which case the interfaces of the terminal 101 may be divided into two classes: interfaces for ad-hoc networks and interfaces for the network infrastructure. However, depending on the type of the mobile terminal 101, it may be provided with one infrastructure interface only, through which the terminal communicates with the access elements of an access network, such as the RAN 102 shown in FIG. 1. In the case of an ad-hoc terminal, there are thus one or more interfaces 610, 611, each offering the functionality needed to accomplish connectivity to an ad-hoc network of a particular type. Several ad-hoc interfaces may be used, at least when the mobile terminal 101 acts as a trunk terminal that serves ad-hoc networks based on different radio technologies. For example, one ad-hoc network served may be based on WLAN technology, while another one may be based on Bluetooth or Ultra-Wideband (UWB) technology. If the terminal 101 is an ad-hoc terminal, but does not act as a trunk node, the communication with a After-Market Digital Content Broker server 111 may occur through a trunk node.

The interfaces to the supporting infrastructure include one or more interfaces 620, 621 of which at least one is used to transfer packet data traffic through the access network.

The terminal 101 may also include a card reader 605 into which an identity module, such as a (Universal Subscriber Module ((U)SIM), User Identity Module (UIM) or a (User) Integrated Circuit Card ((U)ICC) 606 can be inserted. The card reader 605 and the memory unit 630 are connected to the control unit 600 in order that the control unit 600 is able to read data from the identity module 606 and from the memory unit 630 and write data into the identity module 606 and into the memory unit 630.

In addition, the mobile terminal 101 includes a user interface 640 for enabling the user to enter information into, and receive information from, the mobile terminal 101. The user interface 640 typically includes a display and a keypad. Some of the user interactions may involve, as non-limiting examples, entering requests for specific items of desired digital content, granting or denying permission for the After-Market Digital Content Broker server 111 to record in the database 302 the identities of digital content purchased by the user, and accepting or rejecting a request from the After-Market Digital Content Broker server 111 to sell a rights voucher associated with some digital content that has been requested by another user, all as described above in reference to FIGS. 3 and 5. The user interface 640 may also be used for browsing the Internet, for searching for desired content and for subsequently contacting the After-Market Digital Content Broker server 111, which may be located through the sales catalogue 306, as was explained above.

The memory unit 630 includes a tamper-proof memory area 650 for storing the DRM agent 212 and client 215, and the rights and keys databases 213, 214. By executing DRM and other software, and using the data stored in the memory unit 630 and/or in the identity module 606, the control unit 600 performs the above-described operations in connection with the advertising, selling and buying of rights vouchers for digital content, as well as the other operations discussed in relation to FIGS. 3 and 5. In connection with selling, and by example only, the control unit 600 accepts, through the user interface 640, the sales parameters forming the sell order, creates the sell offer message to be sent to the After-Market Digital Content Broker server 111, and performs the steps necessary upon being informed of a sale. In connection with buying and selling, the control unit 600 handles, through the user interface 640, the interaction with the user during the trading session with the After-Market Digital Content Broker server 111.

The data processing environment of the control unit 600 may resemble that of an ordinary PC, and the DRM software (i.e. DRM agent 212, including the client 215 and the novel features of the invention as they pertain to the terminal 101), may be delivered separately to the mobile terminal 101, for example in a multimedia card or by downloading the software through a communication network. It is also possible that certain of the novel features, such as the program code of the client 215, are delivered as a plug-in software module to terminals 101 that are provided with conventional DRM client software. Although the plug-in module may be in the form of a removable memory card storing program code of the portfolio manager, the plug-in module may also be downloaded to the terminal 101 via a communication network. The DRM software or the plug-in module may be downloaded directly to the mobile terminal 101, or through a fixed terminal, such as a PC, from which the software module may further be transferred to the terminal 101.

Although the invention was described above with reference to the examples shown in the appended drawings, it is obvious that the invention is not limited to these, but may be modified by those skilled in the art without departing from the scope and spirit of the invention. For example, the terminal 101 need not be a mobile terminal, but the invention may also be utilized in connection with fixed communication terminals. The communication environment may thus vary according to the terminal 101 used. In general, the various embodiments of the wireless mobile terminal 101 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other, similar or equivalent architectures for the system 100, the After-Market Digital Content Broker server 111 and/or the terminal 101 may be attempted by those skilled in the art.

Further, for the case where the After-Market Digital Content Broker server 111 is successful in purchasing rights for some requested digital content (blocks F and G of FIG. 5), the After-Market Digital Content Broker server 111 may purchase more consumption rights than initially requested, and may hold the remaining rights in inventory for sale, possibly for profit, to another requesting user. As but one non-limiting example, the After-Market Digital Content Broker server 111 may purchase a rights voucher to play a certain song X times, and may sell only Y song plays to a requesting terminal 101, where Y<X. The After-Market Digital Content Broker server 111 and may then hold the remaining (X-Y) song plays in “inventory” and subsequently sell all or a portion of the (X-Y) song plays to another requesting terminal 101. That is, on the occurrence of a subsequent request the method shown in FIG. 5 can be modified to include an additional block, which may be executed before block B (or before or after one of blocks D or F) of determining if the requested digital content is currently held in the inventory of the After-Market Digital Content Broker server 111, and if it is, of fulfilling the request for digital content from the inventory of the After-Market Digital Content Broker server 111.

Further in this regard, the After-Market Digital Content Broker server 111 may pay a mass seller of rights for the right to buy additional rights at a certain price in the future, i.e., the After-Market Digital Content Broker server 111 may purchase a rights option or warrant. In this case the After-Market Digital Content Broker server 111 is enabled to continue to offer certain content at a certain price even though the demand for the content is increasing and driving the price upwards. This particular mode of operation can be especially valuable when offering a hit film or song.

Thus, it can be appreciated that an aspect of this invention is a system and method to conduct business through a communications network, where the method includes locating through the network at least one seller of consumption rights to a digital content; obtaining from the at least one seller an option to purchase consumption rights to the digital content for a certain price in the future and, in response to a request to purchase consumption rights to the digital content, at least one of exercising the option and re-selling purchased consumption rights to the requester, or selling the requestor all or part of the option.

Further, the After-Market Digital Content Broker server 111 may only sell rights to Intermediate brokers, instead of directly to terminals 101, and the Intermediate brokers may then sell the digital content rights directly to the terminals 101. In this case the After-Market Digital Content Broker server 111 may be considered to function as a wholesaler of digital content rights. In some circumstances a given After-Market Digital Content Broker server 111 may function as both a wholesaler and as an Intermediate broker.

While described thus far primarily as an entity located in the network infrastructure, the After-Market Digital Content Broker server 111 may also exist on a terminal 101 and may be controlled by a user. The After-Market Digital Content Broker server 111 may also be a distributed device that resides in a plurality of devices across the network.

Still further, it should be noted that at least some of the blocks in FIG. 5 could be arranged in a different order than shown. For example, block D may be located prior to block B.

However, all such and similar modifications of the teachings of this invention will still fall within the scope of the embodiments of this invention.

Furthermore, some of the features of the preferred embodiments of this invention may be used to advantage without the corresponding use of other features. As such, the foregoing description should be considered as merely illustrative of the principles, teachings and embodiments of this invention, and not in limitation thereof.

What is claimed is:

1. A method to operate a network node to facilitate conveying rights to digital content, comprising:
forming a record in a collection of records of an occurrence of an acquisition of rights to a certain digital content by a first party; and
in response to a receipt of a request through the network from a second party to obtain rights to the certain digital content, examining the records and, if the record is found, contacting the first party through the network to solicit the first party to relinquish at least some remaining rights to the digital content, if any, held by the first party.

2. A method as in claim 1, further comprising, upon the first party agreeing to relinquish at least some remaining rights, facilitating a transfer of the remaining rights to the second party.

3. A method as in claim 2, where facilitating a transfer facilitates a transfer of at least a Digital Rights Management (DRM) Rights Object (RO) to the second party.

4. A method as in claim 2, where facilitating a transfer facilitates a transfer of at least a Digital Rights Management (DRM) Rights Object (RO) and the associated digital content to the second party.

5. A method as in claim 1, further comprising receiving an offer to relinquish rights to a certain digital content from a third party, and advertising the offer in a catalogue that is searchable through the network.

6. A method as in claim 1, further comprising receiving an offer to relinquish rights to a certain digital content from a third party, storing a record of the offer in the collection of records, and in response to a receipt of a request through the network from the second party to obtain rights to the certain digital content, examining the records and, if the record of the offer is found, contacting the third party through the network to facilitate a transfer of at least some of the offered rights to the second party.

7. A method as in claim 1, where in no record is found, attempting to obtain rights to the certain digital content and, if successful, facilitating a transfer of at least some of the obtained rights to the second party.

8. A method as in claim 7, further comprising retaining at least some of the obtained rights, and transferring at least some of the retained rights to another party in response to the receipt of a request through the network from another party to obtain rights to the certain digital content.

9. A method as in claim 7, where the rights are obtained from a source of the digital content.

10. A method as in claim 7, where the rights are obtained from a wholesaler of the digital content.

11. A method as in claim 7, where the obtained rights are transferred to the second party via an intermediate party.

12. A method as in claim 1, where at least a portion of the network is comprised of a wireless communications network.

13. A method as in claim 1, where at least a portion of the network is comprised of a cellular communications network.

14. A method as in claim 1, where at least a portion of the network is comprised of an ad hoc communications network.

15. A network node comprising a controller coupled to a memory and to a network interface, said controller operating in accordance with a stored program to facilitate conveying rights to digital content by forming a record in a collection of records stored in the memory of an occurrence of an acquisition of rights to a certain digital content by a first party, and in response to a receipt of a request through the network interface from a second party to obtain rights to the certain digital content, to examine the collection of records and, if the record is found, to contact the first party through the network interface to solicit the first party to relinquish at least some remaining rights to the digital content, if any, held by the first party.

16. A network node as in claim 15, where said controller operates, upon the first party agreeing to relinquish at least some remaining rights, to facilitate a transfer of the remaining rights to the second party.

17. A network node as in claim 16, where when facilitating the transfer the controller is operable to facilitate a transfer of at least a Digital Rights Management (DRM) Rights Object (RO) to the second party.

18. A network node as in claim 16, where when facilitating the transfer the controller is operable to facilitate a transfer of at least a Digital Rights Management (DRM) Rights Object (RO) and the associated digital content to the second party.

19. A network node as in claim 15, said controller further operating in accordance with the stored program to receive an offer to relinquish rights to a certain digital content from a third party, and to advertise the offer in a catalogue that is searchable through the network interface.

20. A network node as in claim 15, said controller further operating in accordance with the stored program to receive an offer to relinquish rights to a certain digital content from a third party, to store a record of the offer in the collection of records, and in response to receiving the request through the network interface from the second party to obtain rights to the certain digital content, to examine the records and, if the record of the offer is found, to contact the third party through the network to facilitate a transfer of at least some of the offered rights to the second party.

21. A network node as in claim 20, where in no record is found, said controller is further operable to attempt to obtain rights to the certain digital content and, if successful, to facilitate a transfer of at least some of the obtained rights to the second party.

22. A network node as in claim 21, where said controller is further operable to retain at least some of the obtained rights, and to transfer at least some of the retained rights to another party in response to the receipt of a request through the network from another party to obtain rights to the certain digital content.

23. A network node as in claim 21, where the rights are obtained from a source of the digital content.

24. A network node as in claim 21, where the rights are obtained from a wholesaler of the digital content.

25. A network node as in claim 21, where the obtained rights are transferred to the second party via an intermediate party.

26. A network node as in claim 15, where at least a portion of the network is comprised of a wireless communications network.

27. A network node as in claim 15, where at least a portion of the network is comprised of a cellular communications network.

28. A network node as in claim 15, where at least a portion of the network is comprised of an ad hoc communications network.

29. A method to operate a terminal of a communication system, comprising:
in response to a user indicating a desire to acquire consumption rights to a certain digital content, browsing an on-line catalog maintained by an After-Market Digital Content Broker server; and
in response to locating available consumption rights to the certain digital content in the on-line catalog, contacting the After-Market Digital Content Broker server to make an acquisition request for at least some of the consumption rights to the certain digital content.

30. A method as in claim 29, further comprising receiving a transfer of at least a Digital Rights Management (DRM) Rights Object (RO) associated with the certain digital content.

31. A method as in claim 29, further comprising receiving a transfer of at least a Digital Rights Management (DRM) Rights Object (RO) and the associated certain digital content.

32. A terminal comprising a controller coupled to an interface to a communication system and to a user interface, said controller operating under control of a stored program to be responsive to a user indicating a desire to acquire consumption rights to a certain digital content, to browse an on-line catalog maintained by an After-Market Digital Content Broker server and, in response to locating available consumption rights to the certain digital content in the on-line catalog, to contact the After-Market Digital Content Broker server to make an acquisition request for at least some of the consumption rights to the certain digital content.

33. A terminal as in claim 32, further comprising a receiver coupled to the communication system interface to receive a transfer of at least a Digital Rights Management (DRM) Rights Object (RO) associated with the certain digital content.

34. A terminal as in claim 32, further comprising a receiver coupled to the communication system interface to receive a transfer of at least a Digital Rights Management (DRM) Rights Object (RO) and the associated certain digital content.

35. A method to operate a terminal of a communication system, comprising:
in association with a user acquiring consumption rights to a certain digital content, receiving a request for permission to register, in a database of an After-Market Digital Content Broker server, that the consumption rights have been acquired;
responding one of affirmatively or negatively to the request; and
if responding affirmatively, subsequently receiving a solicitation from the After-Market Digital Content Broker server to relinquish at least some remaining consumption rights, if any.

36. A method as in claim 35, where acquiring consumption rights comprises receiving a transfer of at least a Digital Rights Management (DRM) Rights Object (RO) associated with the certain digital content.

37. A method as in claim 35, where acquiring consumption rights comprises receiving a transfer of at least a Digital Rights Management (DRM) Rights Object (RO) and the associated certain digital content.

38. A terminal comprising a controller coupled to an interface to a communication system and to a user interface, said controller operating under control of a stored program to be responsive to a condition where a user acquires consumption rights to a certain digital content, to receive a request for permission to register, in a database of an After-Market Digital Content Broker server, that the consumption rights have been acquired and to respond to the request in one of an affirmative or a negative manner; and if responding affirmatively, to subsequently receive a solicitation from the After-Market Digital Content Broker server to relinquish at least some remaining consumption rights, if any.

39. A terminal as in claim 38, further comprising a receiver coupled to the communication system interface to receive, when acquiring consumption rights, a transfer of at least a Digital Rights Management (DRM) Rights Object (RO) associated with the certain digital content.

40. A terminal as in claim 38, further comprising a receiver coupled to the communication system interface to receive, when acquiring consumption rights, a transfer of at least a Digital Rights Management (DRM) Rights Object (RO) and the associated certain digital content.

41. A storage medium tangibly embodying a program of machine-readable instructions executable by a digital processing apparatus to perform operations to operate a network node to facilitate conveying rights to digital content, the operations comprising:
forming a record in a collection of records of an occurrence of an acquisition of rights to a certain digital content by a first party; and
in response to a receipt of a request through the network from a second party to obtain rights to the certain digital content, examining the records and, if the record is found, contacting the first party through the network to solicit the first party to relinquish at least some remaining rights to the digital content, if any, held by the first party.

42. A storage medium as in claim 41, said operations further comprising, upon the first party agreeing to relinquish at least some remaining rights, facilitating a transfer of the remaining rights to the second party.

43. A storage medium as in claim 42, where facilitating a transfer facilitates a transfer of at least a Digital Rights Management (DRM) Rights Object (RO) to the second party.

44. A storage medium as in claim 42, where facilitating a transfer facilitates a transfer of at least a Digital Rights Management (DRM) Rights Object (RO) and the associated digital content to the second party.

45. A storage medium as in claim 41, said operations further comprising, in response to receiving an offer to relinquish rights to a certain digital content from a third party, advertising the offer in a catalogue that is searchable through the network.

46. A storage medium as in claim 41, said operations further comprising, in response to receiving an offer to relinquish rights to a certain digital content from a third party, storing a record of the offer in the collection of records, and in response to a receipt of a request through the network from the second party to obtain rights to the certain digital content, examining the records and, if the record of the offer is found, contacting the third party through the network to facilitate a transfer of at least some of the offered rights to the second party.

47. A storage medium as in claim 41, where in no record is found, said operations further comprising attempting to obtain rights to the certain digital content and, if successful, facilitating a transfer of at least some of the obtained rights to the second party.

48. A storage medium as in claim 47, said operations further comprising retaining at least some of the obtained rights, and transferring at least some of the retained rights to another party in response to the receipt of a request through the network from another party to obtain rights to the certain digital content.

49. A storage medium as in claim 47, where the rights are obtained from a source of the digital content.

50. A storage medium as in claim 47, where the rights are obtained from a wholesaler of the digital content.

51. A storage medium as in claim 47, where the obtained rights are transferred to the second party via an intermediate party.

52. A storage medium as in claim 41, where at least a portion of the network is comprised of a wireless communications network.

53. A storage medium as in claim 41, where at least a portion of the network is comprised of a cellular communications network.

54. A storage medium as in claim 41, where at least a portion of the network is comprised of an ad hoc communications network.

55. A storage medium tangibly embodying a program of machine-readable instructions executable by a digital processing apparatus to perform operations to operate a terminal of a communication system, the operations comprising:
in response to a user indicating a desire to acquire consumption rights to a certain digital content, browsing an on-line catalog maintained by an After-Market Digital Content Broker server; and
in response to locating available consumption rights to the certain digital content in the on-line catalog, contacting the After-Market Digital Content Broker server to make an acquisition request for at least some of the consumption rights to the certain digital content.

56. A storage medium as in claim 55, said operations further comprising receiving a transfer of at least a Digital Rights Management (DRM) Rights Object (RO) associated with the certain digital content.

57. A storage medium as in claim 55, further comprising receiving a transfer of at least a Digital Rights Management (DRM) Rights Object (RO) and the associated certain digital content.

58. A storage medium tangibly embodying a program of machine-readable instructions executable by a digital processing apparatus to perform operations to operate a terminal of a communication system, the operations comprising:
in response to a user acquiring consumption rights to a certain digital content, receiving a request for permission to register, in a database of an After-Market Digital Content Broker server, that the consumption rights have been acquired;
responding one of affirmatively or negatively to the request; and
if responding affirmatively, subsequently receiving a solicitation from the After-Market Digital Content Broker server to relinquish at least some remaining consumption rights, if any.

59. A storage medium as in claim 58, where acquiring consumption rights comprises receiving a transfer of at least a Digital Rights Management (DRM) Rights Object (RO) associated with the certain digital content.

60. A storage medium as in claim 58, where acquiring consumption rights comprises receiving a transfer of at least a Digital Rights Management (DRM) Rights Object (RO) and the associated certain digital content.

61. A method to operate a network node to facilitate conveying consumption rights to digital content, comprising:
contacting at least one source of consumption rights to a certain digital content;
obtaining, from the at least one source, consumption rights to multiple instances of the certain digital content; and
in response to a receipt of requests through the network to obtain consumption rights to the certain digital content, transferring obtained consumption rights to at least one instance of the certain digital content to a first requestor and transferring obtained consumption rights to at least one other instance of the certain digital content to a second requestor.

62. A method as in claim 61, where the source comprises a wholesaler of the consumption rights.

63. A method as in claim 61, where obtaining comprises purchasing an ability to obtain consumption rights for a certain price in the future.

64. A method as in claim 61, where obtaining comprises obtaining consumption rights through an auction process.

65. A method to operate a network node to facilitate conveying consumption rights to digital content, comprising:
contacting at least one source of consumption rights to a certain digital content; and
obtaining, from the at least one source, consumption rights to at least one instance of the certain digital content through an auction process triggered by an occurrence of a desire to locate a seller of consumption rights to a specific content for which a potential buyer exists.

66. A method as in claim 65, further comprising advertising availability of the consumption rights in an on-line catalog that is browsed by the potential buyer.

67. A method to operate a network node to facilitate conveying consumption rights to digital content, comprising:
receiving a notification that consumption rights to a particular digital content are offered for sale; and
starting an auction process to locate a buyer for the consumption rights to the particular content that are offered for sale.

68. A method to operate a network node to facilitate conveying consumption rights to digital content, comprising:
receiving a plurality of requests to obtain consumption rights to particular digital content; and
starting an auction process to locate a buyer for the consumption rights that offers to pay the most to obtain the consumption rights to the particular digital content.

69. A method to operate a network node to facilitate conveying consumption rights to digital content, comprising:
receiving a plurality of requests to obtain consumption rights to particular digital content; and
starting an auction process to locate a seller of the consumption rights.

70. A method to conduct business through a communications network, comprising
in response to receiving through the network at least one request to obtain consumption rights to a particular digital content, locating a seller of the consumption rights through the network, where locating comprises contacting at least one previous purchaser of the consumption rights;
obtaining consumption rights from at least one located seller; and
re-selling the obtained consumption rights to at least one party making a request.

71. A method to conduct business through a communications network, comprising
in response to receiving through the network at least one request to obtain consumption rights to a particular digital content, locating a seller of the consumption rights through the network, where locating comprises conducting an auction through the network;
obtaining consumption rights from at least one located seller; and
re-selling the obtained consumption rights to at least one party making a request.

72. A method to conduct business through a communications network, comprising
locating at least one seller of consumption rights to a digital content through the network; purchasing consumption rights from at least one located seller; and
re-selling less than all purchased consumption rights to a party making a request for the consumption rights, while retaining at least some purchased consumption rights for re-sale to another party.

73. A method to conduct business as in claim 72, where re-selling re-sells purchased consumption rights to consumers of the consumption rights.

74. A method to conduct business as in claim 72, where re-selling re-sells purchased consumption rights to further re-sellers of the consumption rights.

75. A method to conduct business as in claim 72, where purchasing comprises purchasing an ability to purchase consumption rights for a certain price in the future.

76. A method to conduct business through a communications network, comprising
locating at least one seller of consumption rights to a digital content through the network; obtaining from the at least one seller an option to purchase consumption rights to the digital content for a certain price in the future; and
in response to a request to purchase consumption rights to the digital content, at least one of exercising the option and re-selling purchased consumption rights to the requestor, or selling the requestor all or part of the option.
